(19) United States
(12) Patent Application Publication
(10) Pub. No.: US 2007/0056655 A1
(43) Pub. Date: Mar. 15, 2007

(54) Process for the treatment of wood

(75) Inventor: Peter Vinden, Creswick (AU)

Correspondence Address: DORSEY & WHITNEY LLP, 555 CALIFORNIA STREET, SUITE 1000, SUITE 1000, SAN FRANCISCO, CA, 94104, US

(73) Assignee: University of Melbourne, Parkville (AU)

(21) Appl. No.: 10/562,622

(22) PCT Filed: Jun. 23, 2004
(86) PCT No.: PCT/AU04/00820

§ 371 Date: Aug. 11, 2006

(30) Foreign Application Priority Data
Jun. 25, 2003 (AU) 2003903242

(51) Int. Cl. B27M 1/00

(52) U.S. Cl. 144/380

(57) ABSTRACT

A process for the treatment of wood including: placing the wood to be treated in a treatment vessel and applying a vacuum; exposing the wood to a treatment solution while substantially maintaining said vacuum; applying a predetermined pressure to the wood for a period of time sufficient to partially impregnate the wood with the treatment solution; reducing the pressure within the treatment vessel and concurrently emptying the treatment vessel of treatment solution; whereby immediately after said reduction of pressure within the treatment vessel, the partially impregnated wood includes an unimpregnated inner zone which has a residual vacuum elevating seepage of treatment solution from the partially impregnated wood.

The present invention relates to a process for the treatment of wood More particularly, the invention relates to a process for impregnating wood with a treatment solution, the process involving applying a vacuum to the wood and subsequently pressurizing the wood in a treatment solution to partially impregnate the wood with the treatment solution. Pressure is then reduced and treatment solution concurrently removed from the vessel in which the wood is being treated.

Steam conditioning of green timber or roundwood (for example radiata pine (Pinus radiata D. Don.) under pressure (at approximately 1270 C) in preparation for preservative impregnation has been used for approximately 40 years in New Zealand and Australia. The success of steam conditioning arises from the rupturing of soft radial tissue and moisture loss after steaming and the very high standard of preservative distribution that can be achieved following pressure impregnation.

Steam conditioning generally requires a minimum holding period of 12-24 hours before an alternating pressure method treatment (APM) with copper-chrome-arsenic (CCA) preservatives can be employed, or 7-21 days of air drying after steaming (depending on the diameter of pole and weather conditions) if a Bethel treatment is to be used. These holding periods are needed to achieve moisture losses (up to 300 l/m³) that will provide an adequate treatment standard.

Microwave (MW) conditioning has been proposed as an alternative to steam conditioning. The results of trials to evaluate whether MW irradiation can be used to substitute for steam conditioning indicate that:
MW conditioning results in the same rupturing of ray tissue as achieved with steam;
Full treatment of 90×45 mm timber can be achieved following vacuum pressure (Bethell) impregnation once green sapwood achieves moisture contents of approximately 124%;
Microwave conditioning can be achieved within a few minutes of irradiation; and
High standards of treatment can be achieved in both sapwood and heartwood.

Traditional methods for impregnation of wood include the co-called Bethell treatment, Lowry treatment and Rueping treatment. Schedules for these treatment are illustrated in FIGS. 1 to 3.

Referring to FIG. 1, the Bethell treatment comprises a vacuum/pressure/vacuum treatment as follows:
A) The wood is placed in a retort and evacuated to B (Typically −85 kpa)
B) The wood is held under vacuum until C (typically 30 minutes
C) Preservative is flooded into the treatment cylinder and then pressure applied to D. The pressure may range from 35 kPa when using a permeable wood species and a light organic solvent preservative such as kerosene as the preservative carrier.
D) The pressure is held until the wood is effectively saturated with preservative or until a final rate of flow (for example 4 l/m³) has been achieved which indicates that effectively no more preservative will penetrate the wood.
E) The pressure is released and the pressure in the treatment vessel returns to atmospheric pressure. When pressure is released, any air left in the wood will expand causing preservative to kick-back out of the wood or bleed.
F) To avoid bleeding or kickback, a final vacuum is drawn to G. This causes expansion of air in the wood and accelerated bleeding of preservative solution from the surface.
G) The vacuum is held (generally 30 minutes) so that when the vacuum is released there is a contraction of air in the wood leaving the wood dry to touch.
H) When the vacuum is released, the excess preservative that has collected in the bottom of the retort is pumped back to the storage vessel, prior to opening the door and discharging the treated wood (I).

Referring to FIG. 2, the Lowry treatment is similar to Bethell treatment, except an initial vacuum is not drawn. This results in air being trapped in the wood which is compressed during treatment leading to preservative recovery after treatment and extended kick back.

Referring to FIG. 3, in the Rueping treatment an initial air pressure A-B is imposed. This increases preservative recovery during kickback F-G-H but also extends the dripping time more than 24 hrs. after the treated timber is removed from the treatment plant.

The fixation of CCA preservatives is a time/temperature dependent process. Techniques have been developed to accelerate fixation of CCA by either heating the CCA preservative solution prior to pressure impregnation or heating the wood for treatment or a combination of both of these techniques. The treatment processes used to impregnate the optionally heated wood with hot CCA employ one of the traditional Bethell, Lowry or Rueping treatment processes. Inevitably wood treated in this way results in contamination of the preservative with wood sugars and inevitable sludging or precipitation of the preservative. This results in environmental problems and/or occupational health and safety (OH&S) problems associated with handling of the treated timber. The problems associated with contamination of the preservative solution are partially overcome by segregating the kick back solution from the parent solution during pressure release and final vacuum. The kick back solution generally has a high concentration of wood sugars and may be treated to remove the sugars. This is, however, an expensive process.

An additional problem with traditional treatment methods (Bethel, Lowry, and Rueping schedules and variations of these treatments) is that there is inevitable dripping of preservative when the treated timber is removed from the treatment vessel. This requires the treated timber to be placed on a drip pad. All of these treatments apply a vacuum after treatment to accelerate the recovery of excess preservative that might lead to dripping. This vacuum is successful in reducing the total amount of potential dripping. However, dripping is inevitable as the air trapped in the wood during treatment continues to expand for several hours after removal from the treatment plant. This leads to potential contamination of the treatment site. Research undertaken by the present inventor has indicated that the primary causes of environmental contamination arise from extended dripping and the extent to which preservative components are fixed in the wood during the period of dripping.

The present invention advantageously facilitates accelerated preservative treatment with hot preservatives, for example using hot CCA or hot wood, and overcomes the problems associated with segregating preservatives contaminated with wood sap. The invention also advantageously provides treatments that avoid subsequent dripping of preservative. The combination of these three attributes provides a preservative treatment process that can be conducted very rapidly as an automated conveyor belt treatment, a treatment that is environmentally safer immediately after treatment and safer to handle from an OH&S perspective.

According to the present invention there is provided a process for the treatment of wood including:

placing the wood to be treated in a treatment vessel and applying a vacuum;

exposing the wood to a treatment solution while substantially maintaining said vacuum;

applying a predetermined pressure to the wood for a period of time sufficient to partially impregnate the wood with the treatment solution;

reducing the pressure within the treatment vessel and concurrently emptying the treatment vessel of treatment solution;

whereby immediately after said reduction of pressure within the treatment vessel, the partially impregnated wood includes an unimpregnated inner zone which has a residual vacuum elevating seepage of treatment solution from the partially impregnated wood.

As used herein, reference to “preservative” should be considered reference to the “treatment solution” of the immediately preceding paragraph.

The process of the present invention may be applied to dried wood, partially dried wood, or green wood, but is preferably applied to steam conditioned wood or microwave heated or heated wood. In particular, the process of the invention is advantageously employed to preservative impregnate hot green timber that has been steam conditioned, typically under pressure at 127° C. While steam conditioning is preferred, it will be appreciated that the wood may be dried by other means, such as by microwave heating or by heating with hot air or other conventional techniques.

The process of the invention does not require the use of hot preservative and schedules may be devised utilizing hot or cold preservative or treatment solutions. Similarly, the process is not necessarily limited to schedules that require hot wood to be employed and a combination of hot treatment solution and hot or cold wood may be utilised.

If the wood to be treated is initially steam conditioned, it is not necessarily essential that the vacuum be applied to the wood in the treatment vessel immediately following steam conditioning. Indeed, although it is preferred that the vacuum be applied immediately after steam conditioning, this may be applied up to several hours after steaming. The vacuum is applied to the wood utilizing a treatment vessel. This may be the same treatment vessel in which steam conditioning is conducted. Alternatively, the wood may be steam conditioned in a steam retort and subsequently placed in the treatment vessel for vacuum treatment.

Although the vacuum applied to the wood is preferably between −55 to −90 kPa (gauge), adequate treatment standards may be achieved if lower vacuums are used, such as −40 kPa (gauge). Similarly, higher standards of treatment may be achieved in certain circumstances if a strong vacuum, such as greater than −90 kPa (gauge), is applied to the wood.

The vacuum is generally applied to the wood for approximately 30 to 45 minutes to maximise moisture loss after steaming. In other embodiments, for example where a vacuum is applied to dry timber to effect very rapid evacuation, the vacuum may be applied for as little as a few seconds or minutes. Dry timber may be suitably evacuated in this time period.

It will be recognised from the above discussion that the level of vacuum applied to the wood and the time period of evacuation will be somewhat dependent on the wood being treated and the invention should not be considered necessarily limited to particular levels of vacuum or times for evacuation.

Preservative application to the wood is achieved by drawing preservative into the treatment vessel under the vacuum existing in the treatment vessel. Air pressure can be applied to the preservative entering the treatment vessel thus accelerating its transfer into the treatment vessel. Alternatively the preservative can be pumped into the treatment vessel. The objective is to fill the evacuated treatment vessel with preservative as quickly as possible. It is preferred that the time for introduction of treatment solution into the vessel be no longer than 30 seconds, more preferably in the range of 3-10 seconds. This is considerably faster than conventional water-bourne treatment plants that may take from 3 to 15 minutes and LOSP treatment plant that typically take at least a minute to fill. The fast transfer of solution is particularly advantageous as it reduces within treatment variability arising from longer exposure times of wood to treatment solution lower in the packet of timber and the influence of hydrostatic pressures that increase preservative uptake of timber samples lower in the timber stack.

The current treatment can be applied in existing commercial treatment plants without modification of the plant. However, purpose designed treatment plants may be built so that the treatment vessel is filled in periods as short as 3-5 seconds. This is achieved simply by providing large diameter pipes between the preservative storage vessel and treatment vessel.

Once the treatment vessel is full of preservative, the pressure is raised above atmospheric pressure. Traditional pressure impregnation treatments use pressures of around 1400 kPa. According to one embodiment of the invention, 370 kPa has been found to be suitable for water based preservatives. The time taken to reach 370 kPa. pressure using an experimental commercial plant was found to be approximately 5 minutes. However, in purpose designed plant it may take just a few seconds.

The applied pressure is maintained until the wood, such as timber or roundwood, achieves a predetermined uptake of preservative solution. It will be appreciated that preservative uptake into timber and roundwood will vary between species depending on the moisture content of the wood, the species of timber and whether it is dense with a small air void volume or whether refractory and difficult to impregnate with preservative solution. Preservative uptake will also vary depending on the preservative type, for example water-bourne or light organic solvent or oil, and the treatment schedule used, whether high pressure or low pressure. Each treatment iteration of these variables will have an approximate expected gross uptake of preservative prior to a final vacuum, if applied. The final vacuum may be applied when preservative has been removed from the treatment retort and the timber or roundwood is fully impregnated. The objective is to reduce excess solution, so that there is no preservative dripping when the timber is removed from the treatment plant. Despite the use of long vacuum periods, traditional treatment practices usually fail to render the treated timber free from preservative dripping. However it has been found that if treatment is terminated at a point prior to the maximum typical gross uptake has been achieved, then residual vacuum left in the wood during impregnation will continue to pull preservative into the timber rather than leaving excess preservative on the timber surface for removal by final vacuum.

The point at which pressure is reduced and treatment is terminated to optimise preservative penetration without the need for further final vacuum will vary enormously between species and the commodity being treated.

Green radiata pine which has been steam conditioned to improve permeability and reduce wood moisture content will have an air void volume available for preservative treatment of approximately 280-320 l/m³. If the expected uptake of preservative is 300 l/m³ for a traditional Bethel process, then one might expect to recover say 20 l/m³ by applying a final vacuum on the treated timber. Further dripping will then occur. In the process of the invention the treatment would, for example, be terminated once a gross uptake of 270 l/m³ has been achieved. Research has shown that the residual vacuum in the wood will continue to pull preservative into the wood to achieve similar preservative distribution in the timber but without the need for excessive final vacuum times and without dripping. Clearly further optimisation of the treatment may show that it is possible to reduce gross preservative up to 260 l/m³ without affecting the standard of treatment.

When radiata pine is kiln dried and a Bethel treatment is applied it is possible to achieve preservative uptakes of the order of 550-650 l/m³. However the application of a Rueping treatment where there is substantial recovery of preservative after pressure impregnation, net uptakes as low as 200 l/m³ can be achieved and still meet total sapwood penetration in roundwood and sawn timber. In this example it is possible to apply preservative by the process of the invention to levels of gross uptake as low as 200 l/m³ and achieve preservative penetrations comparable to the Rueping process but without the concomitant contamination of preservative with wood sugars and without excessive preservative dripping after treatment. This represents a major advancement in controlling the environmental problems associated with wood preservation.

In the case of LOSP treatments gross uptakes of preservative into dry radiata pine of the order of 30-50 l/m³ are desirable. This is achieved through a range of processes ranging from Bethel, Lowry and Rueping treatment or Double Vacuum. The objective is to achieve as low an uptake as possible whilst retaining as high a sapwood penetration as possible. In the case of the process of the invention, the plant operator will apply a vacuum and pressure to achieve close to 30 l/m³ and then terminate treatment. This uptake will further distribute into the wood under the residual vacuum. However with the process of the invention there is no need to recover preservative using a final vacuum.

Treatment standards change with time and specifying authorities are now allowing the use of envelope treatments without total sapwood treatment. The process of the invention applies the same general principal to these new standards. Essentially with any existing treatment process there is a net uptake of preservative achieved following a final recovery vacuum. This final net uptake provides a target preservative uptake for wood using the process of the invention whereby a residual vacuum in the wood facilitates final distribution of the preservative without the need for a final vacuum. Simple experimentation may demonstrate that further optimisation of the process of the invention by using a lower gross uptake and substituting higher preservative solution strengths may achieve the desirable preservative retention and distribution whilst shortening the treatment times to achieve the retention and providing drier treated timber surfaces. Typically the target gross absorption of preservative using the process of the invention will be + or −30% of the net preservative absorption achieved by any conventional treatment process. More typically the gross uptake will be the same as the net absorption achieved by existing treatment processes. Preferably the gross uptakes will be up to 30% lower than the net uptakes achieved with all other existing treatment processes. The exact target uptake is determined by experimentation to achieve the same preservative distribution without the need for a final vacuum.

As soon as the predetermined preservative uptake is achieved, (about 5 seconds after reaching pressure) the treatment cylinder is emptied of preservative and the pressure reduced concurrently. This may be achieved by simply opening a valve connecting the treatment vessel with the storage vessel for storing the treatment solution. The higher pressure in the treatment vessel forces the preservative back into the storage vessel. This process may take up to 10 minutes in a traditional treatment plant because of the size of a batch-type treatment vessel (25,000 litres capacity) and because of the small diameter of pipes connecting the storage vessel and treatment vessel. However for a smaller capacity plant (eg. 8,000 litres) and for a plant with large diameter pipes connecting the storage vessel and treatment vessel, this operation can be achieved in just a few seconds (typically 5 seconds).

As previously stated, it has been found that partially impregnating preservative into the wood under pressure and then removing the preservative maintains some vacuum in the wood. Particularly in unimpregnated inner zones of the wood. The result of this is for the wood to continue to pull treatment solution into the wood from the surface and therefore allow no kick-back of treatment solution. The advantage of this is that there is no contamination of the treatment solution. Any preservative kickback inevitably leads to the collection of preservative which is contaminated with wood sugars or air or moisture. An extended sequence of trials using this treatment process indicates that the parent preservative remains in pristine condition. If contaminated preservative (CCA with wood sugars) is employed the preservative very quickly becomes purified as sugars are removed by being deposited in the wood and new preservative is added to the storage tank to replace preservative used in the treatment of wood.

Another advantage of the treatment relates to the much shorter treatment times. This arises from not needing to draw a vacuum on completion of the pressure cycle and the much shorter pressure cycles. Where a purpose built plant is designed, pressure treatment times can be reduced to just a few minutes. This allows the design of a much smaller capacity treatment plant with doors at both ends of the treatment vessel so that conveyor belt treatment can be practiced. The most significant advantage of this treatment process is that when the preservative is removed from the treatment vessel it is completely free of any preservative dripping at any stage after treatment.

The above discussion primarily relates to the treatment of steam conditioned wood. Similar results can be achieved with microwave modified wood. The present invention can also be applied to other preservatives for example water based solutions of boron where there is a desire to minimise net preservative uptake so that the wood (for example framing timber) can be impregnated without increasing its moisture content too severely. The process is particularly suitable for micro-emulsions (i.e. finely divided oil preservatives in water or finely divided water based preservatives in water. There is a particular advantage in this treatment in applying wood resins, wood dimensional stabilising agents or organic solvent treatments where the active ingredient may be sensitive to moisture in the wood. Examples of these treatments include:
The application of water-based starch resins for surface hardening.
The application of isocyanate resins or solvent based resins for Vintorg manufacture (Vinden and Torgovnikov). Isocyanate resins are water sensitive. Any recovery of resins by kickback will inevitably lead to contamination of the parent resin solution with moisture and premature polymerization of resin in the storage vessel.
The application of boron esters (eg. tri-methyl borate) or boron ester resins to wood where the active ingredient is susceptible to hydrolysis or breakdown due to the presence of wood moisture.
The application of acetic anhydride or furfural alcohol for wood modification where speedy liquid application is desirable.

The use of solvent based systems including light organic solvent preservatives will generally need substantially lower treatment pressures. Such treatments can be performed in specially designed plant to provide treatment turn-over times of less than 2 minutes. This increases the productivity of treatment plant and improves the environmental performance of treatment plants and reduces OH&S issues. In all the examples given above the same basic principles apply in relation to the treatment schedule. However, the duration and amount of pressure applied in each cycle may be varied to ensure optimum treatment. Similarly because different wood species vary in their permeability, duration of particular cycles may be varied to compensate for the variability in permeability. The design of treatment plant can vary but in essence the plant configuration can utilise any existing pressure treatment plant design, except preferably, the openings between the storage vessel and treatment vessel are large to allow very rapid transfer of preservative solution to and from the treatment vessel and storage vessel. In a preferred design transfer of preservative utilises compressed air or compressed gas. Another advantage of the process of the invention is that preservative retention is determined directly by gross uptake. There is no loss of preservative following kickback, thus providing very accurate metering of preservative into the wood.

Embodiments of the invention will now be described in more detail with reference to FIG. 4, which illustrates the process of the invention, and the Examples.

With reference to FIG. 4, the process of the invention utilises the same vacuum as a traditional Bethel process (A-B-C). The rapid application of vacuum to the treatment vessel may be achieved by opening a reservoir of vacuum maintained in the vacuum cylinder to the treatment vessel. However, only a relatively short pressure time E-F to apply a specified quantity of preservative is needed to meet a required preservative retention and distribution. The preservative is emptied while maintaining some pressure in the treatment vessel, i.e. the pressure in the treatment vessel is used to accelerate the rate of movement of chemical in the treatment vessel back into the storage vessel. Excessive air pressure is avoided so that air is not forced into the surface of the treated timber. When the treatment vessel is empty and the pressure released, the treated charge of timber can be removed from the vessel without further vacuum.

### EXAMPLES

### Example 1

Green or freshly debarked roundwood of radiata pine measuring between 100 and 150 mm in diameter was steam conditioned at 130° C. for 3 hrs. The round wood was removed from the steam cylinder and placed into a retort and a vacuum applied (−90 kPa. for 1 hour) to continue boiling and removing wood sap. The retort was then flooded with 2% Copper Chrome Arsenic (CCA) preservative and pressurized to 370 kPa, held at this pressure for 5 minutes until an uptake of 275 l/m³ had been achieved and then the pressure released and the preservative emptied. The posts were removed immediately from the cylinder. The posts were dry to touch and there was no kickback of preservative solution. Cross cutting of sample posts and spot testing for preservative penetration indicated that total preservative penetration had been achieved in the roundwood.

### Example 2

Kiln dried radiata pine sapwood measuring 95×45 mm in cross section was placed in a retort as indicated in FIG. 1. The plant comprised a door at both ends of the treatment vessel to facilitate easy entry and discharge from the vessel. A conveyor belt loading and unloading system provided rapid charge loading and unloading. Evacuation of the wood was achieved using a vacuum reservoir (a separate vessel that had been evacuated prior to the charge entering the treatment vessel and the doors closing. The wood was instantly evacuated and the vacuum maintained at −85 kPa. gauge for 25 seconds. Preservative solution was then flooded into the treatment plant by opening valves between the storage tank and treatment vessel. Rapid transfer of preservative solution (in this case a 2% solution of trimethyl borate mixed with 50:50 linseed oil and kerosene) was achieved by opening a number of large diameter pipes between the storage vessel and treatment vessel. Rapid transfer of preservative was aided because of the vacuum in the treatment vessel, but also because the preservative was pressurized in the store vessel. Filling of the treatment vessel took 4 seconds. Because of the air pressure used to transfer preservative from the store tank to the treatment plant, once the treatment vessel was full of preservative it immediately came on to pressure. Once a predetermined pressure had been achieved, in this case 5 kPa (gauge), and a gross uptake of chemical had been achieved, in this case 30 l/m³, the pressure was released and the preservative solution emptied into a storage vessel in approximately 4 seconds.

It will be recognised that tri-methyl borate is sensitive to moisture and is also volatile. The advantage of this process is to avoid loss of preservative due to volatilization and also avoid contamination of the parent solution with wood sap. As in example 1 there is no kickback and no final vacuum to remove residual preservative. There is therefore no contamination of the parent preservative. The process is on-line because there is conveyor belt feed of the packet of timber through the plant. Timber is weighed before during and after treatment in situ to provide plant control on a mass/mass basis. Since there is no kickback or final vacuum, treatment uptake can be calculated very easily. It will also be understood there is no restriction on the type of chemical that can be applied by this method. For example it is proposed that resins can be applied by the method outlined as well as water based preservatives such as CCA. In the case of water based solutions it is anticipated that higher pressures are used for example up to 700 kPa.

### Example 3

Experimental determination of environmental enhancement of copper-chrome-arsenic treatment operations at a commercial treatment plant.

In a first series of scoping trials conducted experimentally using a commercial plant the process of the invention was tested as a means of eliminating dripping. These trials used an initial vacuum of −90 kPa. applied to freshly steamed wood (held for an hour prior to evacuation). Preservative treatment pressure was raised to 700 kPa and held for 10 minutes. No air pressure was applied. Pressure was reduced slowly and the treatment plant emptied. No final vacuum was employed. The results of this treatment indicated a high standard of preservative distribution. Effectively there was no preservative kickback from this treatment process. However, 3 drips of CCA solution were observed as emanating from the charges of treated timber. This was regarded as unacceptable.

A second series of scoping trials compared the use of lower pressure of 375 kPa. and shorter pressure treatment times, effectively 2 minutes at 375 kPa. Air pressure was used on the charge to maintain pressure during preservative emptying. This was a precaution to ensure that an adequate standard of preservative penetration was achieved. However, the results indicated that the level of dripping increased over and above the first scoping trials indicating the application of air pressure at the end of pressure impregnation resulted in the in-depth penetration of air into the treated wood and preservative kick-back. The same schedule was tested without the use of air pressure to test the standard of preservative treatment. The results indicated that the process of the invention without optional air pressure could provide an adequate standard of preservative penetration with a total absence of any preservative dripping after treatment.

The scoping trials also tested the feasibility of steam evacuation to meet adequate moisture loss in roundwood prior to preservative impregnation. Steam evacuation has been used previously to accelerate the loss of moisture after steam conditioning, however the timber or roundwood is allowed to cool when treated with CCA because of sludging of the CCA solution when it becomes heated. Normally the Steam Conditioning/APM treatment method is applied to steam conditioned wood which is cool and left for at least 12-24 hours or in the case of Bethel treatment has been left for at least 7 days to achieve moisture loss (300 l/m³) from the green condition and moisture redistribution. The objective of the scoping trials was to determine whether adequate moisture loss could be achieved by steam evacuation immediately after steaming. Two schedules were examined and compared.

In the first schedule steam evacuation in the treatment vessel was conducted one hour after steaming had been completed. In the second schedule, there was no delay between steaming and then placing the steamed material in the treatment vessel and continuing moisture evaporation from the timber under vacuum. The vacuums were nominally −85 kPa. However, a consistently high standard of vacuum was achieved (−92 kPa). In all cases the vacuum was maintained for 45 minutes. The results of these trials indicated that a consistent standard of preservative distribution could be achieved irrespective of whether the vacuum was applied within 5 minutes of steam conditioning or an hour after steam condition.

### Example 4

Work has been conducted to test the consistency of preservative treatment and preservative fixation using the schedules defined during the two initial scoping trials. It was anticipated that the application of the process of the invention to steam conditioned and evacuated round-wood would provide treated charges completely free of any kickback and any preservative dripping and treated timber with effectively completely fixed preservative immediately after treatment. In the trials described below the fixation of freshly steamed timber is compared with cold timber.

Treatment Schedule

Wood was delivered to the treatment cylinder directly from the steamer, the maximum time between steaming and treatment being 1 hour. A vacuum was then applied to −85 kPa minimum for 45 minutes and the treatment cylinder flooded using the vacuum. The cylinder was then pressurized to 370 kPa and held at pressure for 5 seconds. The pressure was then slowly released with a ramp down time of 10 minutes. The cylinder was then pumped empty and the treated material held under cover for 4 hours to allow complete fixation of the preservative.

Chemical Composition

CrO₃=47.8%

CuO=22.9%

As₂O₅=29.3%

The solution strength of CCA was 2.63%

The Gross/Net Uptake of CCA was 242 litres/m³.

Ambient temperature=13° C.

Temperature of treatment cylinder (solution):

Before treatment=25.4° C.

After treatment=26.8° C.

Materials

Radiata pine posts

Age—thinned material (aged 7 yrs)

Length=1.79 m

Diameter 115 mm (each pole)

On average there were 85 poles in each pack

The Average Curved Surface Area (CSA)=323,185 mm² (2ΠrL)—the CSA is used as it represents the area that is exposed to rainfall. (Appendix 2).

4 packs of pre-heated packs.

4 cold packs as controls.

Collection of Solution Samples

Black Polythene plastic—3 m×3 m

5 Litre Pressurized Garden Sprayer—“Rain Maker”

16 Glass vials—8 for collecting solution samples, and 8 for collecting core samples

Chemical Used for Analysis

Titration—for Determining the Presence of Chromium.

Potassium Dichromate (10.387 grams)

Ferrous Ammonium Sulphate (140.201 grams)

Barium Diphenylamine Sulphate (0.280 grams)

Concentrated Sulphuric Acid (500 ml)

Spraying—Determining the Extent of Preservative Penetration

Rubeanic Acid—Dithiooxamide (1.002 grams)

Ethanol (10 ml)

Ammonia Solution (diluted in distilled water to 7:1)

Methodology

Simulated Rainfall Technique for Leaching Studies

According to Wally, S. (1996) “The Fixation Mechanisms of Copper Chrome Arsenate (CCA) Wood Preservatives”, The Author, The University of Melbourne, the volume of water used for the simulation of rainfall plays an important and influential role in the amount of leaching that occurs, (i.e. “the more water that is applied, the more leachate that will occur. This is true for both within a certain period and overall”). Walley (1996) therefore concluded that the volume of water to be used would need to be adapted to the situation, which in this case is the rainfall pattern of the area in which the test is being undertaken.

The equation for determining the volume of water to be used in the simulated rainfall technique=
Average Rainfall of Area×Surface Area of Pack (1)
Average Annual Rainfall for Southern Australia over the past 10 years=690 mm=13 mm/weekly
Curved Surface Area of pack=323, 185 mm²
Volume to be used=323,185 mm2×13 mm=4,201,405 mm3=4,201 cm=4,201 ml=approximately 4 litres
Simulated Rainfall Technique

The sixteen (16) packs were each designated separate sites under the cover of the drying shed, and placed on the prepared polythene plastic immediately after treatment. The periphery of the plastic was raised to allow the entrapment of solution and prevent run-off during and after spraying. Water was sprayed evenly over the packs ensuring that all exposed surfaces were watered. The sprayer nozzle intensity was adjusted to provide a fine spray and simulate a drizzling effect. Fifteen minutes duration of spraying was adopted when dispensing the quota of water for each time interval.

The packs were left to drip for a few minutes before removal. Core samples of two randomly selected poles were extracted and placed in a vial. Solutions samples were then collected and placed in a separate vial. Each vial was labelled and dated.

The spraying and collection procedures were repeated in accordance to the pre-determined time intervals, i.e. 4 hrs, 9 hrs and 24 hrs.

Determining the Rate of Fixation

AS/NZS 1605:2000 (2^{nd} Edition) for “Determination of Chromium in CCA Preservation (Pg 42 & 43)”, the back-titration method was adopted in determining the level of chromium in the solution of CCA leachate.

Determining Preservative Penetration

AS/NZS 1605:2000 (2^{nd} Edition) for “Determination of Copper penetration in timber treated with Copper-based preservatives—Method 1”, the extent of penetration was determined for the core samples.

Observations and Results

State of Packs Immediately after Treatment

The state of the poles, for both the pre-heated and cold packs, immediately after treatment was “touch-dry” and completely free of any dripping.

Apart from the central segment, the entire column of each core sample showed presences of copper, from the blue-black coloration exhibited. There were no significant differences in the percentage penetration for each sample, as the extent of coloration throughout each column exhibited an equal extent of coloration.

Concentration of Cr in the CCA Leachate Following Simulated Rainwetting.

TABLE 1
The concentration of Cr (VI) in CCA Leachate (g/l)

| SPECIMEN | % Cr (VI) | Cr (g/l) | Cr (mg/l) |
|---|---|---|---|
| Heated - 1 Hr | 0.005 | 0.0623 | 62.30 |
| Heated - 4 Hrs | 0 | 0 | 0 |
| Heated - 9 Hrs | 0 | 0 | 0 |
| Heated 24 Hrs | 0 | 0 | 0 |
| Cold - 1 Hr | 0.003 | 0.0445 | 44.5 |
| Cold - 4 Hrs | 0.0018 | 0.02225 | 22.25 |
| Cold - 9 Hrs | 0.0007 | 0.0089 | 8.90 |
| Cold - 24 Hrs | 0.0007 | 0.0089 | 8.90 |

The results are illustrated graphical in FIG. 5 which illustrates a plot of Concentration of Cr vs. Collection Time.

For both specimens, i.e. the cold and heated packs, the concentration of chromium (Cr) in the solution leachate decreases over time.

For the heated packs, there was a higher concentration of Cr collected in the solution leachate when sprayed after an hour, in comparison to that which was treated cold. The concentrations were 62.3 mg/i and 44.5 mg/l respectively.

By the 4^{th} hour, the solutions collected from the heated packs exhibited no Cr content. Solutions collected from the cold pack continued to exhibit concentrations of Cr, but in decreasing amounts up to the 24^{th} hour.

### CONCLUSIONS

The results of these experimental trials confirm that:
(i) A high standard of preservative (CCA) treatment can be achieved in radiata pine round-wood following steam evacuation prior to pressure impregnation. The recommended evacuation time at −85 kPa. is 45 minutes. It may be possible to reduce this evacuation time. However, further experimental work is required before any reductions in steam evacuation time can be recommended. A delay of up to one hour between steaming and evacuation has no impact on the quality of treatment. Longer delays may be possible without compromising the standard of treatment. However, it is recommended that evacuation is undertaken as soon as practicable after steaming.
(ii) The process provides completely drip free charges of wood immediately after treatment. This is an important contributing factor to the high level of fixation of CCA in the wood immediately after treatment and effectively controls the potential for preservative leaching into the environment. The process reduces any potential for preservative kickback during treatment. This is also an essential element in the success of the treatment because the quantity of wood sugars being kick-backed into the parent preservative is minimised. This facilitates the use of heated CCA without the formation of sludge. From an environmental perspective this represents a major advance in the environmental application of CCA preservatives. The absence of sludge formation will minimise the production toxic waste that needs disposal and will provide cleaner treated products. This was evident in the series of experimental trials undertaken at commercial plant. By the time the trials were completed the quality of finish. (absence of sludge and fines on the surfaces of treated wood) was dramatically reduced. The recommended schedules for use with steam conditioned roundwood includes a treatment pressure of 375 kPa with the pressure treatment being terminated once this working pressure has been held for 2 minutes or less. No final vacuum should be applied. Some flexibility is needed in treating different commodities where minor variations may be needed to optimise the treatment schedule.
(iii) Accelerated fixation was achieved through a combination of heating the timber (by steam conditioning) and heating the preservative solution. The ambient temperature at the commercial treatment plant was 13° C. where as the steady state treatment solution temperature was 25° C. The trials indicated a major improvement in fixation by having hot wood. The slightly better initial result for cold wood may have arisen from a higher air pressure in hot wood immediately after treatment compared to the cold wood. However within 4 hours after treatment the amount of Cr available for leaching is effectively zero. One is led to the conclusion that the steam conditioned timber needs to be held for 4 hours prior to sale. However, further work could fine tune this holding period to a shorter period. There is also an option of heating the CCA solution to a higher temperature (for example 30-50° C. or even higher).

### REFERENCES

Australian and New Zealand Standard™ (2^{nd} Edition) Methods for sampling and analysing timber preservatives and preservative treated timber. Determination of Copper Penetration in Timber Treated with Copper Based Preservatives—Method 1 (Pg 14) and Determination of Hexavalent Chromium in CCA Preservative Solution (Pg 42-43)
Bergervoet, A. J. (1983) Pre-steaming radiata-pine heartwood to improve treatability. International Research Group on Wood Preservation. IRG/WP Doc No. 3239 Surfers Paradise, Australia.
McQuire, A. J. (1974) The Treatment of partially seasoned pine posts by the Bethell process. Proceedings of the NZ. Wood Preservers Association. Annual Conference 1974.
Torgovnikov G., Vinden P., Mapanda E., Cobham, P. (1999). The Application of Microwaves for Preservative Treatment of Wooden Posts. Proceedings, Seventh International Conference on Microwave and High Frequency Heating, 14-17 September, Valencia, Spain.
Torgovnikov G., Vinden P. (2000) Microwave Modification of Wood Properties: Improvements in Wood Permeability. International Conference of IRJ 31, IRG/WG-40181, 14-19 May, Kona, Hi., USA.
Torgovnikov G., Vinden P., J. Romero (2000a) Microwave Conditioning of Pinus Radiata D. Don for Preservative Treatment, International Conference of IRG 31, IRG/WG-40182, 14-19 May, Kona, Hi., USA.
Torgovnikov G., Vinden P., Mapanda E., Cobham P. (2000b) Rapid Fixation of Chromated Copper Arsenate by Microwave Treatment, International Conference of IRJ 31, IRG/WG-40184, 14-19 May, Kona, Hi., USA.
Torgovnikov G., Vinden P. (2000) Microwave Modification of Yellow Sringybark (Eucalyptus muelleriana) Posts for Impregnation with Copper-Chrom-Arsenic (CCA) Preservative. International Conference of IRJ 31, IRG/WG-40185, 14-19 May, Kona, Hi., USA.
Vinden, P. and McQuire, A. J. (1978). Improvements to APM Schedules. Proceedings 19th New Zealand Wood Preservers Association. 18: 21-36.
Vinden, P. and McQuire, A. J. (1980). Developments in Wood Preservation processing techniques in New Zealand. International Research Group on Wood Preservation. Doc. No. IRG/WP/3123 11th meeting Raleigh, N. Carolina. USA.
Vinden, P. (1985). APM and Q treatment of Pinus caribaea roundwood. IUFRO S.5.03 Wood Preservation Meeting. Wood Preservation in Tropical Countries. May 17, 1985 Guatuja, S P, Brazil.
Vinden, P., and Cobham, P., (1996) “Process of treating wood with preservatives” International patent no. WO 96/335560.
Vinden P., Romero J., Torgovnikov G. (1999) A Method for Increasing the Permeability of Wood., World Intellectual Property Organization, Patent application IPN WO 99/64213
Vinden P., Torgovnikov G., (1999) Modified wood product and process for the preparation thereof. Patent application PQ6316/00.
Vinden P. and Torgovnikov G., (2000) The Physical Manipulation of Wood Properties Using Microwave. Proceedings (p. 240-247), International Conference of IUFRO, The Future of Eucalypts for Wood Production, 19-24 March, Tasmania, Australia.
Walley, S. (1996). The Fixation Mechanisms of Copper Chrome Arsenate (CCA) Wood Preservatives. The Author, The University of Melbourne.

1. A process for the treatment of wood including:
placing the wood to be treated in a treatment vessel and applying a vacuum;
exposing the wood to a treatment solution while substantially maintaining said vacuum;
applying a predetermined pressure to the wood for a period of time sufficient to partially impregnate the wood with the treatment solution;
reducing the pressure within the treatment vessel and concurrently emptying the treatment vessel of treatment solution;
whereby immediately after said reduction of pressure within the treatment vessel, the partially impregnated wood includes an unimpregnated inner zone which has a residual vacuum elevating seepage of treatment solution from the partially impregnated wood.

2. The process of claim 1, wherein the wood to be treated is dried wood, partially dried wood or green wood.

3. The process of claim 1, wherein the wood to be treated is steam conditioned wood or microwave heated or heated wood.

4. The process of claim 1, wherein the vacuum applied to the wood is between −55 to −90 kPa (gauge).

5. The process of claim 1, wherein the vacuum is applied to the wood for up to approximately 45 minutes.

6. The process of claim 1, wherein the time for introduction of treatment solution into the treatment vessel is no longer than 30 seconds.

7. The process of claim 5, wherein the time for introduction of the treatment solution into the treatment vessel is from 3-10 seconds.
